(19) United States
(12) Patent Application Publication
(10) Pub. No.: US 2020/0331017 A1
(43) Pub. Date: Oct. 22, 2020

(54) PORTABLE AUTO SPRAYER

(71) Applicant: Farm Solution Co., Ltd., Chungcheongnam-do (KR)

(72) Inventor: WON KYOUNG LEE, Daejeon (KR)

(73) Assignee: Farm Solution Co., Ltd., Chungcheongnam-do (KR)

(21) Appl. No.: 16/804,046

(22) Filed: Feb. 28, 2020

(30) Foreign Application Priority Data
Apr. 19, 2019 (KR) 10-2019-0045913
Dec. 17, 2019 (KR) 10-2019-0168917

(51) Int. Cl. B05B 12/02; B05B 12/00

(52) U.S. Cl. CPC B05B 12/02; B05B 12/002

(57) ABSTRACT

Disclosed is an automatic spray. The automatic spray includes a main body containing a mixed liquid, a pump unit contained in a space formed at a lower portion of the main body to provide power for discharging the mixed liquid, a battery module contained in the space to supply electric power to the pump unit, and a control unit contained in the space to control the supply of the electric power of the battery module to the pump unit, wherein the control unit includes a pair of male and female connectors as a connection part for receiving a current from the battery module or outputting a control current for controlling a speed of the pump unit, and each of the pump unit and the battery module includes one of male and female connectors connectable to the male and female connectors of the control unit.

### BACKGROUND OF THE INVENTION

### 1. Field of the Invention

The present invention relates to a portable auto sprayer, and more particularly, to an automatic spray which has a simple structure by modularizing a plurality of electrical components and allows a user to easily determine whether a component is failed.

### 2. Description of the Related Art

In most of the arable land except for the cultivated land of organic products, spraying chemicals such as pesticides is recognized as a necessary work.

In order to perform such a chemical liquid spraying operation quickly, farms have sprayed pesticides using sprayers. In addition, as a commonly used spray, there is a manual spray in which a pump is pumped by the elevating operation of the plunger by a handle operation, and the chemical liquid is sprayed accordingly.

In addition, there is an automatic spray which uses a power to operate a pump to pump a chemical liquid. According to a manual sprayer, generally, the plunger provided in a spray container is moved up or down by operating a handle lever installed at a side low end portion of the spray container, thereby spraying the chemical liquid stored in the spray container through the spray hole by the compressing operation. Thus, with a heavy spray container on the shoulder, an operator has to continuously lift and press the handle lever with one hand, so that there is a difficulty in performing the work.

To the contrary, the pump of the automatic atomizer is operated by a power unit driven by an engine at a position of the spray container. Thus, the pump is operated by the motor using a power source such as a battery, thereby performing spraying.

In addition, the automatic spray, which is used to reduce the effort of the operator, has a head pump for strongly discharging chemical liquid mixture through a plurality of outlets after compressing the chemical liquid mixture sucked into a chemical liquid inlet.

In addition, one side has a suction hose connected to the chemical liquid mixture inlet port of the head pump and the other side to the chemical liquid mixture reservoir. That is, the head pump sucks and compresses the chemical liquid mixture located in a large-capacity chemical liquid mixture storage reservoir through a suction hose, such that the chemical liquid mixture can be injected at a high pressure through a nozzle of the spray.

In the case of the automatic spray that sprays the mixed liquid using a motor, as circuits therein, the automatic spray includes a voltmeter, a speed regulator for adjusting the speed of a pump motor, a main switch for turning on and off the power applied to the pump motor from the battery, and a fuse. Thus, it is not only easy to cause a failure due to such a complicated control configuration, but also a long time is required to clearly determine the location of the failure.

### SUMMARY OF THE INVENTION

The present invention is to propose an automatic spray of which an inner circuit configuration is modularized to simplify the configuration and reduce the failure rate, and in particular, which enables a general user, who is not an expert of an electronic device, to easily determine a failure portion even if the automatic spray including a battery and a circuit module fails.

In addition, the present invention is to propose an automatic spray in which a bypass switch is provided in a control unit which is one of the modules, such that the power supplied from a battery module can be bypassed to a pump unit even if the control unit is not turned on, so it is easy to identify a failed module.

To achieve the objects described above, according to one aspect of the present invention, there is provided an automatic spray which includes a main body containing a mixed liquid; a pump unit contained in a space formed at a lower portion of the main body to provide power for discharging the mixed liquid; a battery module contained in the space formed at the lower portion of the main body to supply electric power to the pump unit; and a control unit contained in the space formed at the lower portion of the main body to control the supply of the electric power of the battery module to the pump unit, wherein the control unit includes a pair of male and female connectors as a connection part for receiving a current from the battery module or outputting a control current for controlling a speed of the pump unit, and each of the pump unit and the battery module includes one of male and female connectors connectable to the male and female connectors of the control unit.

According to the embodiments of the present invention, the automatic spray includes the modularized control unit to further improve the productivity, and includes the connector that enables a user to easily identify a fault portion or fault part, so that the user can replace the part quickly.

### BRIEF DESCRIPTION OF THE DRAWINGS

FIGS. 1 and 2 are views illustrating the outer appearance of an automatic spray according to the present invention;

FIG. 3 is a view illustrating a modularized control unit, a battery module and a pump unit according to a first embodiment of the present invention;

FIG. 4 is a view illustrating a state in which a control unit, a battery unit and a pump unit according to the first embodiment of the present invention are connected to each other;

FIG. 5 is a view illustrating a modularized control unit according to a second embodiment;

FIG. 6 is a view illustrating a state in which the control unit, the battery module and the pump unit according to an embodiment of the present invention are connected;

FIG. 7 is a block diagram illustrating a function of the bypass switch in the configuration module of the automatic nebulizer according to an embodiment of the present invention; and

FIG. 8 is a view illustrating a connection state when a user determines whether a failure occurs according to an embodiment of the present embodiment.

### DETAILED DESCRIPTION OF THE INVENTION

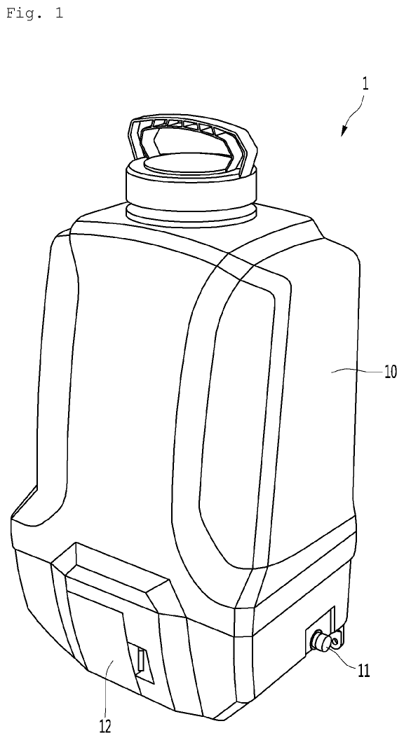

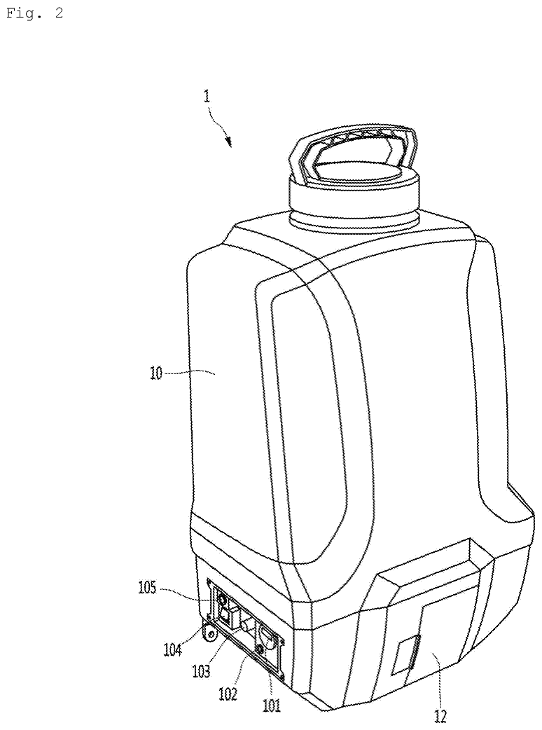

FIGS. 1 and 2 are views illustrating the outer appearance of an automatic spray according to the present invention.

Referring to FIGS. 1 and 2, an automatic spray 1 includes a main body 10 in which a drug mixed liquid and the like are contained, and a control device and a pump for discharging the mixed liquid contained in the main body, which are provided in a lower portion of the main body 10.

The automatic spray 1 includes an outlet part 11 provided in the lower portion thereof to discharge the mixed liquid contained in the main body 10 therethrough, a battery for supplying power to operate a pump motor, and a control device including a main switch, a fuse, and the like, and a battery removable cover 12 that is opened and closed to contain a battery therein.

According to an embodiment of the present invention, the automatic spray 1 includes a pump unit for providing power for discharging the mixed liquid contained in the main body 10 through the outlet part 11, a control unit for controlling the operation of the pump unit and the motor speed, and a power unit for supplying electric power to the control unit and the pump unit, which are arranged in the space provided in a lower portion of the main body 10. Specifically, the control unit is formed with a plurality of components modularized.

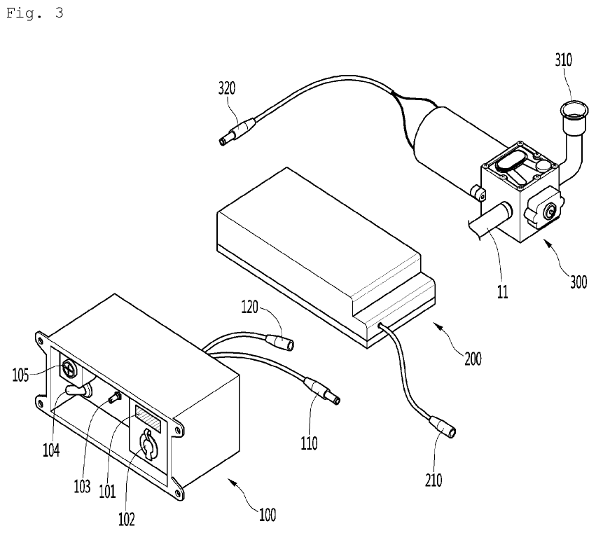

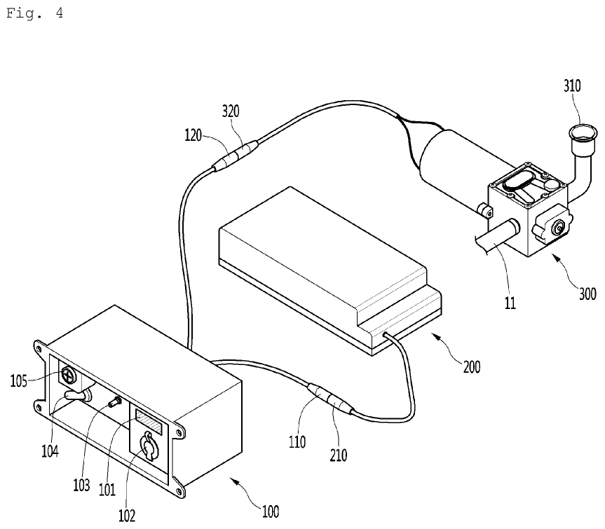

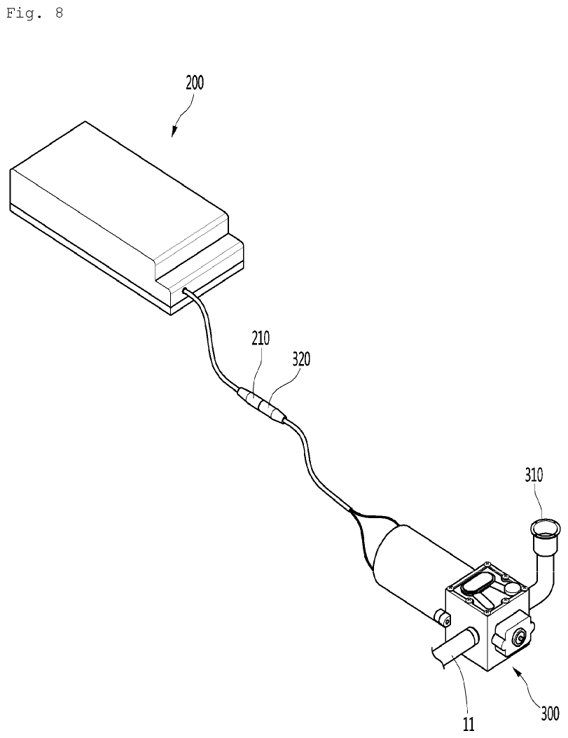

FIG. 3 is a view illustrating a modularized control unit, a battery module and a pump unit according to a first embodiment of the present invention. FIG. 4 is a view illustrating a state in which a control unit, a battery unit and a pump unit according to the first embodiment of the present invention are connected to each other. FIG. 8 is a view illustrating a connection state when a user determines whether a failure occurs according to an embodiment of the present embodiment.

For reference, the connection state for determining whether a failure illustrated in FIG. 8 may be applied regardless of the types of the control units control of the first and second embodiments.

First, the control unit of the first embodiment illustrated in FIG. 3 is configured in a state where a plurality of electrical components are modularized in the containing space in a lower portion of the main body 10. In addition, the control unit 100 includes a voltmeter 101, a speed regulator 103 for adjusting the motor speed of the pump unit, a charging hole 102 in which a terminal for charging a battery 200 is formed, a switch 104 for turning on and off the operations of the automatic spray and the motor, and a fuse 105 for stably supplying electric power, each of which is modularized.

In addition, the control unit 100 includes a male connector 110 and a female connector 120 as connection parts for receiving a current or outputting a control current for controlling the motor speed.

According to the embodiment, only the control unit 100 includes both the male and female connectors. Each of the battery unit 200 and the pump unit 300 include only one of the male and female connectors.

For example, the battery unit 200 may include only a female connector 210 which is a terminal for supplying electric power to an external device or charging a battery. In this case, the pump unit 300 includes only a male connector 320.

This is because even if a user lacks the electrical knowledge, when the automatic spray is broken, the user can pinpoint a component that has failed. When the user connects the battery unit 200 capable of supplying power to the pump unit 300, if the motor of the pump unit 300 is operated, it is possible to understand that the battery unit 200 and the pump unit 300 are not faulty. This will be described in more detail below with reference to the accompanying drawings.

Meanwhile, if the battery unit 200 is formed not with the female connector 210 for the connection to an external device but with a male connector, the power connector of the pump unit 300 is formed with a female connector unlike that shown in FIG. 2.

The power connectors that are formed in the control unit 100, the battery unit 200 and the pump unit 300, respectively may be 5521 DC waterproof connectors. They may be readily replaced with other power connectors if the male and female connectors are distinguished from each other and have simple structures.

The motor for discharging the mixed liquid contained in the main body 10 of the automatic sprayer through the outlet part 11 is disposed in the pump unit 300, and the mixed liquid moves into the pump unit 300 through a main body connecting part 310 connected to the main body 10.

As shown in FIG. 4, the male connector 110 of the control unit 100 is connected to the female connector 210 of the battery unit 200, and the female connector 120 of the control unit 100 is connected to the male connector 320 of the pump unit 300.

In the case where the power connector is configured according to the present embodiment, it is possible to achieve a normal connection very easily even if the actual farming users separate and reassemble the electronic components.

Although the female connector 210 of the battery unit 200 and the male connector 320 of the pump unit 300 may be connected, since the two connectors of the control unit 100 are not connected, three components may be normally combined/assembled based on the control unit 100.

However, in the case of an automatic spray, the automatic spray belongs to an article that is roughly handled in the field, so that a failure may occur in one of the control unit, the pump unit and the battery unit. In this case, the manufacturer of the automatic sprayer has a hassle that the repair staff must travel directly to the place, or the failed automatic sprayer must be sent to the manufacturer.

In spite of the convenience of the automatic spray which automatically sprays the mixed liquid, inconvenience may occur due to the repair procedure and the repair period. According to the embodiment, the user can easily determine the failed device through a simple operation, and accordingly the manufacturer can send the failed device quickly, so that the repair period may be significantly shortened.

When the automatic atomizer is broken, it is possible to determine the failed device by connecting the male connector 210 of the battery unit 200 and the female connector 320 of the pump unit 300 as shown in FIG. 8.

If the battery unit 200 and the pump unit 300 are directly connected to each other and the motor of the pump unit 300 operates, since the control unit, but not the battery unit 200 and the pump unit 300, is broken, from the manufacturer's point of view, if only the control unit 100 is sent quickly, the failure problem can be solved.

If the control unit 100 is not modularized, the user may not be able to send a difficult electric component so that the broken electric component must be directly repaired by the repairman. However, as the components are modularized, the user may quickly repair the broken component.

To the contrary, if the battery unit 200 and the pump unit 300 is directly connected to each other and the motor of the pump unit 300 does not operate, it may be determined that the pump unit 300 is failed. This is because the battery unit 200 is one of the components which does not fail except when discharged. Thus, in this case, it is sufficient for the manufacturer to send the pump unit 300 to the user.

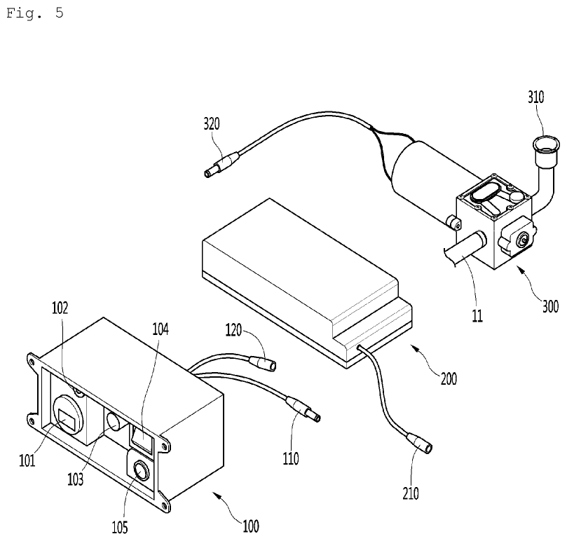

FIG. 5 is a view illustrating a modularized control unit according to a second embodiment.

As shown in FIG. 5, a modularized control unit according to the second embodiment includes a display unit 101 which allows a user to check whether the spraying is performed and the spraying amount, a charging port 102 including a terminal for charging the battery module 200, a switch 104 for turning on or off the operation of the automatic spray and the motor, a speed regulator 103 for adjusting the motor speed of the pump unit, and a bypass switch 105 which allows the user to check easily and simply a module in which an error occurs when the operation of the spray is abnormal, each of which is modularized.

As will be described in detail below, the bypass switch 105 performs an operation of transmitting the electricity supplied from the battery module 200 to the control unit 100 and an operation of directly transmitting the electricity supplied from the battery module 200 to the pump unit 300. Therefore, when the user operates the bypass switch 105 to perform the bypass operation of directly transmitting the electricity supplied from the battery module 200 to the pump unit 300, it may be determined that a failure occurs in the control unit 100 when the pump unit 300 is normally operated. If the pump unit 300 does not operate, it may be determined that a failure has occurred in the pump unit 300.

When the user does not input the bypass switch 105 and directly connects the module to determine whether there is a failure, as an additional discriminating unit for accurately sorting out the failed component, if the motor of the pump means 300 operates when the user connects the battery module 200 capable of supplying electric power and the pump unit 300, it may be known that the battery module 200 and the pump unit 300 are not out of order. This will be described in more detail below with reference to the accompanying drawings.

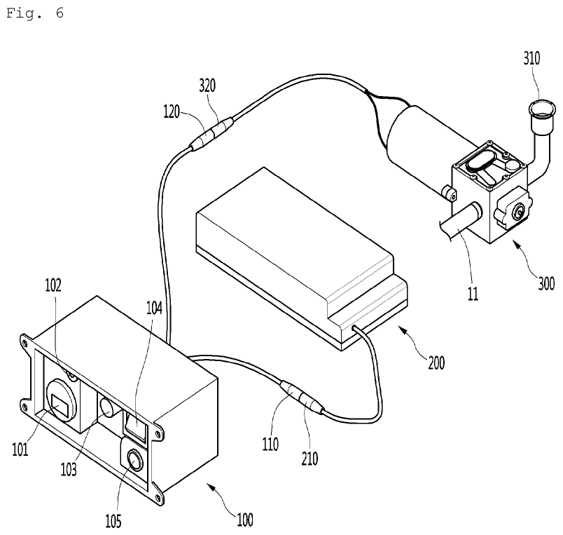

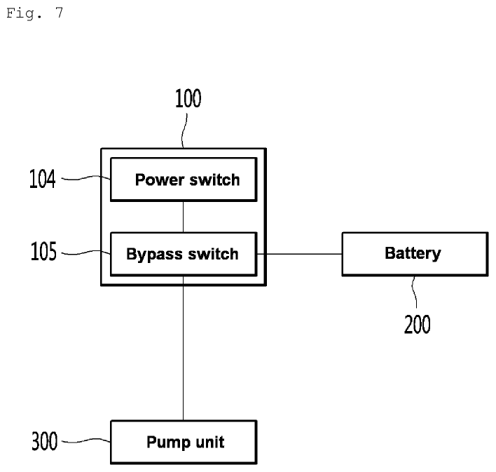

FIG. 6 is a view illustrating a state in which the control unit, the battery module and the pump unit according to an embodiment of the present invention are connected. FIG. 7 is a block diagram illustrating a function of the bypass switch in the configuration module of the automatic nebulizer according to an embodiment of the present invention.

As shown in FIG. 6, the male connector 110 of the control unit 100 is connected to the female connector 210 of the battery module 200, and the female connector 120 of the control unit 100 is connected to the male connector 320 of the pump unit 300.

In the case where the power connector is configured according to an embodiment, it is possible to achieve a normal connection very easily even if farming users actually separate and reassemble the electronic components.

Although the female connector 210 of the battery module 200 and the male connector 320 of the pump unit 300 may be connected, since the two connectors of the control unit 100 are not connected, three components may be normally combined/assembled based on the control unit 100.

However, in the case of an automatic spray, the automatic spray belongs to an article that is roughly handled in the field, so that a failure may occur in one of the control unit, the pump unit and the battery module. In this case, the manufacturer of the automatic sprayer has a hassle that the repair staff must travel directly to the place, or the failed automatic sprayer must be sent to the manufacturer.

In spite of the convenience of the automatic spray which automatically sprays the mixed liquid, inconvenience may occur due to the repair procedure and the repair period. According to the embodiment, the user can easily determine the failed device through a simple operation, and accordingly the manufacturer can send the failed device quickly, so that the repair period may be significantly shortened.

That is, as shown in FIG. 7, the configuration for supplying power from the battery module 200 to the control unit 100 is configured to pass through the bypass switch 105. Therefore, even when the power switch 104 of the control unit 100 is turned off, by operating the bypass switch 105, the power of the battery module 200 is directly supplied to the pump unit 300, so that it may be confirmed that the pump unit 300 normally operates. As a result, it is possible to easily determine whether the pump unit 300 or the control unit 100 is failed.

The fact that a power switch 104 of the control unit 100 is turned off means that the display unit 101 does not operate and various kinds of control circuits and components do not operate. However, in the embodiment, the bypass switch 105 may be operated by an on/off or push/pull scheme to directly bypass the power/current of the battery module 200 to the pump unit, so that it is possible to specify a module in which a failure has occurred.

What is claimed is:

1. An automatic spray comprising:
a main body containing a mixed liquid;
a pump unit contained in a space formed at a lower portion of the main body to provide power for discharging the mixed liquid;
a battery module contained in the space formed at the lower portion of the main body to supply electric power to the pump unit; and
a control unit contained in the space formed at the lower portion of the main body to control the supply of the electric power of the battery module to the pump unit,
wherein the control unit includes a pair of male and female connectors as a connection part for receiving a current from the battery module or outputting a control current for controlling a speed of the pump unit, and
each of the pump unit and the battery module includes one of male and female connectors connectable to the male and female connectors of the control unit.

2. The automatic spray of claim 1, wherein the pump unit includes a male connector connectable to the female connector of the control unit, and
the battery module includes a female connector connectable to the male connector of the control unit.

3. The automatic spray of claim 2, wherein the female connector of the battery module and the male connector of the pump unit are connectable to each other, and
a motor of the pump unit is operated by a connection of the battery module and the pump unit when neither the pump unit nor the battery module has failed.

4. The automatic spray of claim 1, wherein the control unit is formed by modularizing a power switch configured to selectively supply electric power to circuit components constituting the control unit, a speed regulator configured to adjust a motor speed of the pump unit, and a bypass switch connected to the battery module and configured to selectively bypass the electric power supplied from the battery module to the pump unit by an operation of a user.

5. The automatic spray of claim 4, wherein the bypass switch is configured to selectively perform a first operation of transferring the electric power supplied from the battery module to the power switch and a second operation of bypassing the electric power supplied from the battery module to the pump unit.
